(19) United States
(12) Patent Application Publication
(10) Pub. No.: US 2025/0030011 A1
(43) Pub. Date: Jan. 23, 2025

(54) CATALYST LAYERS, MEMBRANE ELECTRODE ASSEMBLIES AND POLYMER ELECTROLYTE MEMBRANE FUEL CELLS EQUIPPED THEREWITH, AND METHODS OF MAKING

(71) Applicant: The Trustees of Indiana University, Bloomington, IN (US)

(72) Inventors: Jian Xie, Zionsville, IN (US); Chenzhao Li, Bolingbrook, IL (US)

(21) Appl. No.: 18/775,322

(22) Filed: Jul. 17, 2024

Related U.S. Application Data
(60) Provisional application No. 63/513,966, filed on Jul. 17, 2023.

(51) Int. Cl. H01M 4/92; H01M 4/86; H01M 4/88; H01M 8/1004; H01M 8/1018

(52) U.S. Cl. CPC H01M 4/926; H01M 4/8657; H01M 4/8892; H01M 8/1004; H01M 8/1018; H01M 2250/20

(57) ABSTRACT

A catalyst layer is provided herein that includes a catalyst support having positively charged surfaces, nanoparticles on the surfaces of the catalyst support, and negatively-charged ionomer films on the catalyst support and the nanoparticles thereon. The ionomer films may be formed on the catalyst support to be substantially uniform, conformal and thin by controlling electrostatic charge of the surfaces of the catalyst support, for example by utilizing electrostatic charge attraction between positively charged surfaces of the catalyst support and negatively-charged ionomer films. The catalyst layer may be incorporated into a membrane electrode assembly, a polymer electrolyte membrane fuel cell, and myriad other applications and uses.

### CROSS-REFERENCE TO RELATED APPLICATIONS

This application claims the benefit of U.S. provisional patent application No. 63/513,966, filed Jul. 17, 2023, the contents of which are incorporated herein by reference. This application is also related to PCT/US2017/055021 filed Oct. 4, 2017, which claims the benefit of U.S. Provisional Application No. 62/404,055 filed Oct. 4, 2016, the contents of which are also incorporated herein by reference.

### BACKGROUND OF THE INVENTION

The present invention generally relates to catalyst layers, such as of the type capable of use in membrane electrode assemblies (MEAs), for example, of polymer electrolyte membrane fuel cells (PEMFCs). The invention also relates to methods of producing an ionomer/catalyst interface within such catalyst layers, particularly characterized by having thin, uniform, and conformal ionomer films covering catalyst particles of the catalyst layers.

With the surge of interest in electrification of transportation driven by global climate change, the need for powertrains using non-carbon energy sources has become more urgent than ever. Fuel cell electric vehicles (FCEVs) that use a polymer electrolyte membrane fuel cell (PEMFC) have advantages over internal combustion engines and other renewable energy vehicles, as examples, high efficiency, zero emission, fast fueling, unique power and energy scalability (without heavy penalty from increased mass).

Polymer electrolyte membrane fuel cells (PEMFCs) utilize membrane electrode assemblies (MEAs) that traditionally have a proton (or polymer) exchange membrane (PEM) between a pair of catalyst layers (CLs), each of which is applied to or otherwise contacted by a gas diffusion layer (GDL) that functions as an electrode (anode or cathode). Examples of electrodes currently used in MEAs include a catalyst layer including a porous support, catalyst nanoparticles applied to the support (such a support is commonly referred to as a catalyst support), and an electrolyte film overlying the catalyst nanoparticles to form an electrolyte/catalyst interface where the oxygen reduction reaction (ORR) occurs. A portion of such an MEA 10 is schematically represented in FIG. 5, in which a catalyst layer 12 comprising a catalyst 14 dispersed on a support 16 is disposed between a PEM 18 and electrode 20. In the nonlimiting configuration depicted in FIG. 5, catalyst supports, catalyst nanoparticles, and electrolytes used in MEAs have included, respectively, carbon-containing particles, platinum group metal (PGM) nanoparticles (NPs), and ionomers.

After decades of intensive development, there are far fewer FCEVs currently on the road in comparison to the millions of battery electric vehicles (BEV) in use. Besides the lack of hydrogen infrastructure, a major obstacle for FCEV development is the cost of the PEMF C system, in which PGM catalysts (primarily platinum (Pt)) account for up to 42% total cost of a PEMFC system. Although current Pt usage has been reduced to 22.5 g Pt per 90 kW stack, the ultimate goal of 5 g Pt has still not been achieved. Further reduction of the Pt usage is critically needed for large-scale PEMFC commercialization.

Considerable effort has been devoted to the development of PGM and PGM-free catalyst materials. However, catalysts that exhibit excellent intrinsic catalytic performance as measured by a rotating disk electrode (RDE) do not always show promising performance in an MEA, which is the core component in a PEMFC system. For instance, a catalyst of Pt nanoparticles distributed on the surfaces of particles of a conductive carbon black commercially available under the name Vulcan7 XC72 (Cabot Corporation) has been shown to exhibit very high mass activity, for example, 0.3 A/cm² at 0.90 V, but in an MEA the same such catalyst has been reported to exhibit a mass activity of about 0.15 A/cm². A longstanding challenge for PEMFCs is the ability to translate the excellent intrinsic RDE performance of a catalyst into an MEA.

A fundamental of this challenge lies with the structure of the catalyst layers in an RDE versus an MEA. In an RDE catalyst layer, each individual catalyst particle (e.g., Pt nanoparticle) is well dispersed over the surface of a glassy carbon disk and fully exposed to a liquid electrolyte, as schematically represented in FIG. 1A. Namely, the surface of each catalyst particle is almost 100% accessible for the liquid electrolyte except the portion in contact with the carbon disk or with another particle. Hence, a complete electrolyte/catalyst interface is established. Consequently, the dissolved oxygen molecules and protons (H⁺) can diffuse from the bulk of the electrolyte to the ionomer/catalyst interface to participate in the ORR while the electrons are transferred to the interface via the carbon disk. With such a structure, every catalyst particle (except those agglomerated) is utilized for catalyzing the ORR process, achieving a very high catalyst utilization. In contrast, FIG. 1B schematically represents a catalyst layer of an MEA, in which an ionomer is used as a solid electrolyte instead of a liquid electrolyte. The ORR process occurs at an electrolyte (ionomer)/catalyst interface formed where a film of the solid ionomer covers surfaces of catalyst nanoparticles (Pt) on the surface of a carbon support (C), as is schematically represented in FIG. 1C. Unlike an RDE catalyst layer, in which all exposed catalyst surfaces can form an electrolyte/catalyst interface, in an MEA catalyst layer an exposed catalyst surface does not form an ionomer/catalyst interface if the surface is not covered by the ionomer film, as evident from FIG. 1B. As a consequence, benchmark testing has shown that catalyst performances are critically different in RDEs and MEAs. More specifically, the performance difference is constrained by mass transfer and PGM utilization, which are results of the ionomer/catalyst interface in an MEA, as compared to an RDE. Therefore, the performance difference between an RDE and an MEA arises from the difference in the electrolyte/catalyst interface. The transferability challenge is to approach in an MEA the catalyst interface achieved with an RDE catalyst layer. At the ionomer/catalyst interface, three species—O₂ molecules (diffusing through the ionomer film after traveling a long path through the pores of the catalyst layer), proton H⁺ (transferring along the ionomer film), and electrons (sequentially flowing via the carbon support and then the Pt particles)—simultaneously reach the same site of the ionomer/catalyst interface to complete the ORR process (FIG. 1C). Thus, the ionomer/catalyst interface becomes the centerpiece of the PEMFC from the fundamental perspective since this is where the ORR occurs.

Significant efforts have been dedicated to the CL/MEA development while relatively little attention has been paid to construction of an ideal ionomer/catalyst interface. Ionomers as both proton conductor and binder have revolutionized the CL/MEA structure, but doing so has not been purposely focused on the ionomer/catalyst interface. In current approaches, particles of the catalyst have been combined with an ionomer solution to form a catalyst ink, from which the solvent is evaporated to form a porous catalyst layer. The formed ionomer/catalyst interface is the result of randomly precipitated ionomer agglomerate/films over the catalyst and carbon support surface, which are neither uniform nor thin due to the presence of oxygen-containing groups (e.g., ketone, quinone, carboxylic, etc.) on the carbon support surface, which repel the ionomer particles due to negative charged SO₃⁻ groups of the ionomer. Very often, this leads to less ionomer/catalyst interfaces because a significant amount of the catalyst surfaces remains uncovered by an ionomer film.

To increase the ionomer/catalyst interface, one approach is to use excessive amounts of ionomer, which may increase the coverage but with the heavy penalty of increasing the O₂ diffusion barrier resulting from a thicker ionomer film through which the O₂ must diffuse, reducing the high current density performance. Although recently developed highly oxygen-permeable ionomers (HOIPs) can significantly improve O₂ diffusion through the ionomer film, the ionomer/catalyst interface remains a challenge. Research has been reported in which improved the ionomer distribution on catalyst surfaces has been achieved using nitrogen (N) doped carbon, but the science behind this phenomenon has not been discussed in detail, and the reported performance is not significantly higher than catalyst supported by untreated carbon.

In view of the above, it can be appreciated that there are certain problems, shortcomings, or disadvantages associated with existing MEAs intended for use in PEMFCs. In particular, it would be desirable if a more ideal ionomer/catalyst interface could be achieved.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, catalyst layers, membrane electrode assemblies and polymer electrolyte membrane fuel cells equipped therewith, and methods of making catalyst layers.

According to a nonlimiting aspect of the invention, a catalyst layer includes a catalyst support having surfaces that are positively charged, nanoparticles on the surfaces of the catalyst support, and negatively-charged ionomer films on the catalyst support and the nanoparticles thereon, the ionomer films being uniform, conformal, and thin over the nanoparticles.

Oher nonlimiting aspects of the invention include methods of produced catalytic layers having elements as described above, as well as membrane electrode assemblies and polymer electrolyte membrane fuel cells equipped therewith.

Technical aspects of catalyst layers as described above preferably include the capability of achieving a more ideal ionomer/catalyst interface to increase catalyst utilization (e.g., high mass activity and electrochemical active surface area) and O₂ diffusion rate (e.g., high current density performance) without compromising proton conduction. Some benefits may include, for example, production of a thin, uniform, and conformal ionomer film that covers more surfaces of catalyst nanoparticles to increase catalyst utilization, (e.g., high mass activity and electrochemical active surface area) and O₂ diffusion rate (e.g., high current density performance) without compromising proton conduction

Other aspects and advantages will be appreciated from the following detailed description.

### BRIEF DESCRIPTION OF THE DRAWINGS

FIGS. 1A and 1B schematically represent, respectively, the structure of a catalyst layer of a rotating disk electrode (RDE) and the structure of a catalyst layer of a membrane electrode assembly (MEA).

FIG. 1C schematically represents a more ideal ionomer/catalyst interface of an MEA as compared to FIG. 1B.

FIG. 1D schematically represents interactions between negative (−) charged ionomer particles and positive (+), neutral, and negative (−) charged catalyst/carbon particles of an MEA.

FIGS. 2A through 2D are graphs plotting particle size distribution of catalyst inks that contain catalyst particles (Pt nanoparticles on carbon particles). FIG. 2A plots particle size distributions of the catalyst inks that also contain an ionomer and in which the catalyst particles are positively-charged (NH₂), or negatively-charged (SO₃H), or lack any charge (referred to herein as neutral or “blank”). FIG. 2B plots particle size distributions of catalyst inks that contain the positively-charged (NH₂) catalyst particles with and without the ionomer, FIG. 2C plots particle size distributions of catalyst inks that contain the neutral catalyst particles with and without the ionomer, and FIG. 2D plots particle size distributions of catalyst inks that contain the negatively-charged (SO₃H) catalyst particles with and without the ionomer.

FIGS. 2E through 2G contain cryo-transmission electron microscope (cryo-TEM) images of catalyst inks containing, respectively, positively-charged catalyst particles, neutral catalyst particles, and negatively-charged catalyst particles.

FIGS. 3A through 3F contain cryo-TEM images of powders scratched from cathode catalyst layers formed with positively-charged (NH₂) catalyst particles (FIGS. 3A and 3B), neutral catalyst particles (FIGS. 3C and 3D), and negatively-charged (SO₃H) catalyst particles (FIGS. 3E and 3F).

FIGS. 4A through 4C are SEM images showing the thicknesses of catalyst layers formed with, respectively, positively-charged (NH₂), neutral, and negatively-charged (SO₃H) catalyst particles.

FIGS. 4D and 4E are, respectively, an SEM image showing the pore structure of a catalyst layer formed with positively-charged (NH₂) catalyst particles and an image after FIB/SEM slicing and 3D reconstruction (pores are highlighted).

FIGS. 4F and 4G are, respectively, an SEM image showing the pore structure of a catalyst layer formed with negatively-charged (SO₃H) catalyst particles and an image after FIB/SEM slicing and 3D reconstruction (pores are highlighted).

FIG. 4H is a graph plotting differential (mercury) intrusion porosimetry results of catalyst layers formed with positively-charged (NH₂), neutral (“blank”), and negatively-charged (SO₃H) catalyst particles.

FIG. 4I is a graph plotting pore volume of catalyst layers formed with positively-charged (NH₂) catalyst particles, neutral (“blank”) catalyst particles, and negatively-charged (SO₃H) catalyst particles.

FIG. 5 schematically represents a fragmentary cross-section of an MEA, including a PEM, electrode (gas diffusion layer), and catalyst layer thereof.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s), and certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

A catalyst layer is provided herein that includes a catalyst support having positively charged surfaces, nanoparticles on the surfaces of the catalyst support, and negatively-charged ionomer films on the catalyst support and the nanoparticles thereon. Advantageously, the ionomer films are substantially uniform, conformal, and thin over the nanoparticles. In some optional configurations, the catalyst support may be made of and/or include carbon particles. The catalyst support surfaces may be positively charged with —NH3+ functional groups. The catalyst support surfaces may be covalently grafted with p-benzylamine group to have the —NH3+ functional groups on the surfaces. In other embodiments, the catalyst support surfaces may covalently grafted polyaniline, polybenzimidazole, and/or derivatives thereof to have the —NH3+ functional groups on their surfaces. In some configurations, the ionomer films may have negatively-charged SO3—groups on their surfaces. The ionomer films may be formed of a sulfonated tetrafluoroethylene-based fluoropolymer copolymer. The ionomer films may be formed of one or more of p-benzenesulfonic acid, p-benzoic acid, and derivatives thereof. In some configurations, the nanoparticles may include or be any one or more of Pt, Rh, Pd, Ag, Au, Ni, Os, Ir, Mn, and Co, and the alloys, intermetallics, and oxides thereof. The nanoparticles may be any one or more of platinum, ruthenium, rhodium, palladium, osmium, and iridium, alloys thereof, and ordered intermetallics thereof.

In addition, a method of producing the catalyst layer described herein is provided herein. The method includes forming the ionomer films on the catalyst support to be uniform, conformal, and thin by controlling electrostatic charge of the surfaces of the catalyst support. In some optional configurations, this may include utilizing electrostatic charge attraction between the positively charged surfaces of the catalyst support and the negatively-charged ionomer films. In some nonlimiting examples, the ionomer films may be formed on the catalyst supports by combining positive charged catalyst particles and negatively-charged ionomer particles in a catalyst ink containing a solvent and then removing the solvent to form a solid ionomer film. In other nonlimiting examples, the ionomer films may be formed on the catalyst supports by dispersing an ionomer powder and a catalyst powder in the solvent, in which the catalyst powder includes positively-charged carbon particles having the nanoparticles on their surfaces. This mixing creates the catalyst ink within which ionomer/catalyst interfaces form as a result of the ability of particles of the catalyst powder and the ionomer powder to freely move and interact in the solvent.

It is anticipated that a wide variety of uses and products could implement the catalyst layer described herein. For example, a membrane electrode assembly may incorporate the catalyst layer. In another example, a polymer electrolyte membrane fuel cell may incorporate the membrane electrode assembly that incorporates the catalyst layer. In another example, a self-propelled vehicle, such as an automobile, boat, airplane, spaceship, motorcycle, bicycle, etc., may incorporate the polymer electrolyte membrane fuel cell to provide energy for powering motors, electronics, and/or other mechanisms. Of course, these catalyst layers and polymer electrolyte membrane fuel cells could be implemented in many other types of applications and uses, and the invention is not necessarily limited to any one of these example use scenarios. Additional and/or alternative optional embodiments, features, details, examples, are detailed in the following description of various investigations leading to the present invention.

In investigations leading to the present invention, ionomer/catalyst interfaces were engineered utilizing electrostatic attraction between positively-charged catalyst particles and negatively-charged ionomer particles in catalyst inks, and then preserving the electrostatic attraction in solid catalyst layers (comprising ionomer films on catalyst particles) that are capable of use in, as a nonlimiting example, a membrane electrode assembly (MEA). The ionomer/catalyst interfaces yielded previously unachieved proton exchange membrane fuel cell performances in both catalyst utilization (e.g., 75% versus 45%) and peak/rated power density (e.g., 1.430/0.930 W cm⁻², H₂-air, cathode Pt loading: 0.1 mg_{Pt} cm⁻²) for pure Pt catalysts, exceeding those of Pt alloy catalysts. The investigations demonstrated the formation of ionomer/catalyst interfaces in the liquid phase of the catalyst inks (using ultra-small angle X-ray scattering (USAXS) in combination with cryo-TEM, isothermal-titration-calorimetry) and the preserved ionomer/catalyst interfaces in the solid catalyst layers (using TEM) and estimated the effective coverage and thicknesses of the ionomer films (using the limiting current density, rotating disk electrode (RDE), and fuel cell performance).

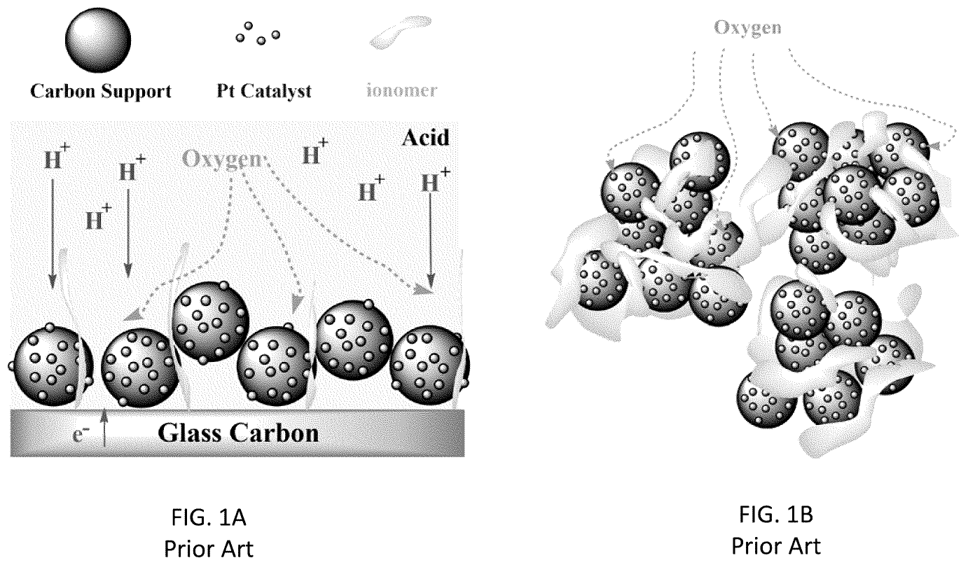

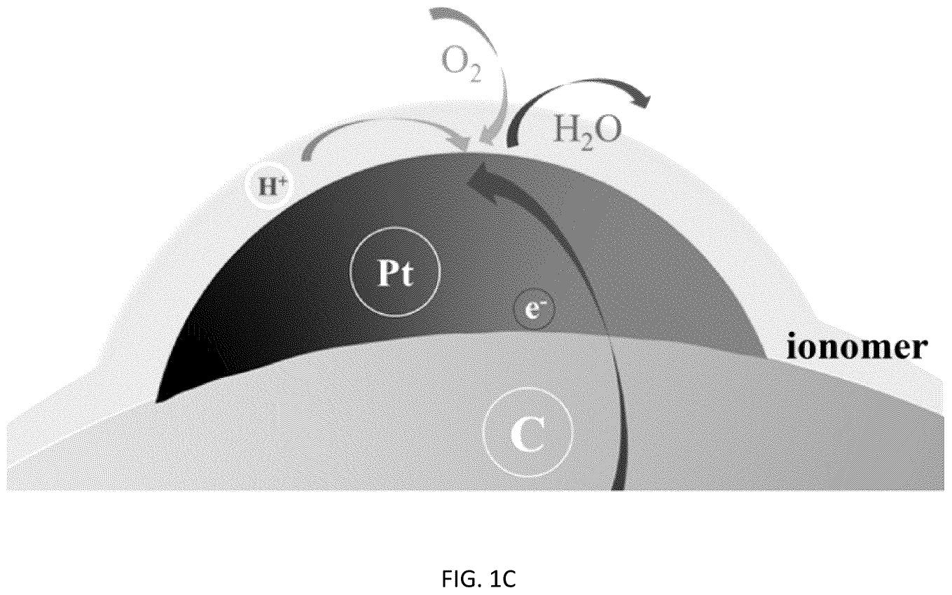

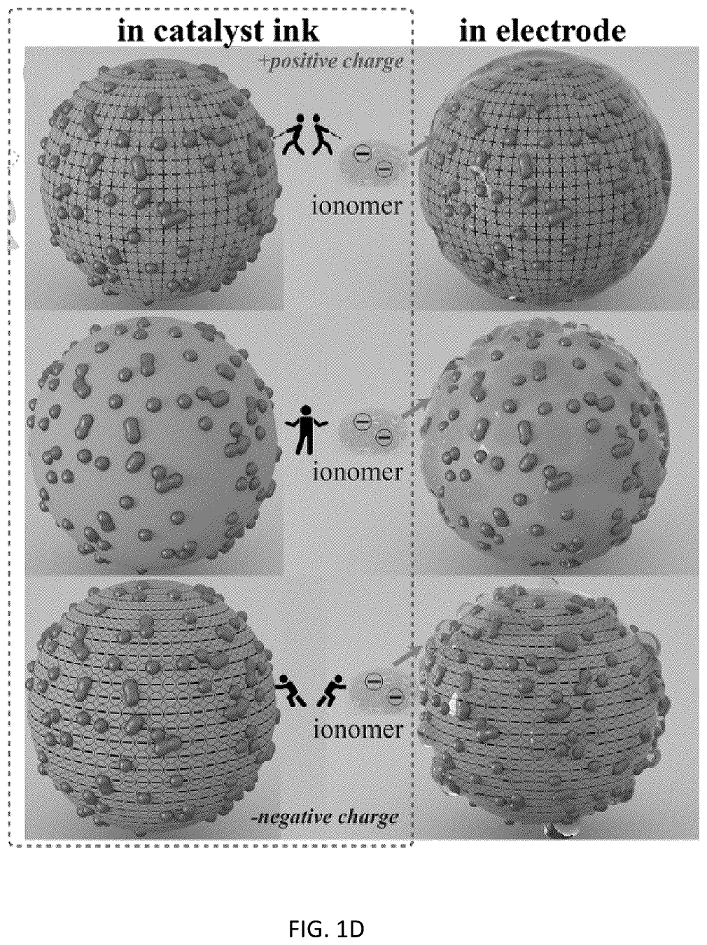

From the investigations, an approach was proposed to rationally design a more ideal ionomer/catalyst interface, schematically represented in FIG. 1C, and construct such an interface utilizing an electrostatic attraction force between positively-charged catalyst particles and negatively-charged ionomer particles. Instead of uncontrolled thus random formation of an ionomer/catalyst interface, the formation of the ionomer/catalyst interface is controlled in the liquid phase (i.e., catalyst ink) via charge attraction, and an ionomer/catalyst interface is spontaneously formed characterized by a more uniform, conformal, and thin ionomer film (FIG. 1D), which is believed to promote catalyst utilization (e.g., promote mass activity and electrochemical active surface area) and O₂ diffusion (e.g., promote current density performance) without compromising proton conduction. Such an intentionally engineered interface leads to significantly improved MEA performance in terms of mass activity, ECSA, and rated/peak power density, beyond that reported in the prior art. In addition, this approach can be directly used to fabricate high-performance MEAs for PEMFCs, which would be capable of accelerating the commercialization of PEMFCs. Finally, this approach demonstrated a method of solving practical engineering challenges associated with PEMFCs through establishing a property (ink)-structure (interface)-performance relationship for a more ideal ionomer/catalyst interface.

The nonlimiting investigations were performed with platinum (Pt) particles used as the catalyst particles and carbon particles used as catalyst supports, together forming a catalyst layer. However, catalyst particles formed of other materials are believed to be within the scope of the invention, including but not limited to one or more of Pt, Rh, Pd, Ag, Au, Ni, Os, Ir, Mn, and Co, and the alloys, intermetallics, and oxides thereof. For the investigations, the carbon particles were treated with p-benzylamine to have positively-charged —NH₃⁺ functional groups on their surfaces, though other treatments (e.g., with polyaniline, polybenzimidazole, derivatives, etc.) capable of providing positively-charged functional groups are also believed to be within the scope of the invention. More specifically, for catalyst functionalization and synthesis, the introduction of the NH₂ groups on carbon surface was realized using the diazonium reaction. P-phenylenediamine, Vulcan XC72, and nitric acid were mixed in a flask, sonicated using a sonication bath, heated to 65° C. in an oil bath, and finally sodium nitrite solution was added into the mixture dropwise followed by 18 hours of heating in an oil bath at 65° C. After the reaction, the mixture was washed using DI-water and ethanol, then filtered, and dried in a vacuum oven over night at 60° C. After confirming the covalently bonded NH₂ groups onto carbon surface, Pt nanoparticles were loaded by reducing precursor (H₂PtCl₂) in a mixture of ethylene glycol and DI water at 140° C. for six hours. Finally, the dispersion was filtered followed by drying overnight in a vacuum oven at 60° C. In addition, the nonlimiting investigations evaluated a well-known ionomer commercially available under the name NAFION® (a sulfonated tetrafluoroethylene-based fluoropolymer copolymer) from the Chemours Company as a negatively-charged ionomer having negatively-charged SO₃⁻ groups on its surfaces. The same method was applied for SO₃H functionalization but replacing P-phenylenediamine with sulfanilic acid. However, other negatively-charged ionomers with other negatively-charged groups (e.g., p-benzenesulfonic acid, p-benzoic acid, derivatives thereof, etc.) are also believed to be within the scope of the invention.

The investigations were conducted with the intent of achieving ionomer/catalyst interfaces having the following ideal features: (1) the surfaces of the catalyst particles (except those portions in contact with the carbon particles) should be completely covered by ionomer films so that all surfaces of the catalyst particles participate in ORR, which, in turn, leads to a nearly 100% catalyst utilization, as does the high mass activity and the electrochemical active surface area (ECSA), and (2) the ionomer films should be as thin as possible to minimize O₂ diffusion resistance through it so that the limiting current density can reach the maximum, consequently, the max power performance. Meanwhile, the thicknesses of the ionomer films should not be excessively reduced to the extent that proton conduction is compromised. To utilize the charge attraction between catalyst and ionomer particles to control the formation of the ionomer/catalyst interfaces, surfaces of carbon particles were covalently grafted with p-benzylamine group (—NH₃⁺ after hydration) and then loaded with Pt nanoparticles (yielding catalysts referred to herein as Pt/V_{NH2} catalysts). When such positively-charged Pt/V_{NH2} catalyst particles were mixed in a water-based solution with ionomer particles that were negatively-charged with —SO₃⁻ groups, it was hypothesized that, similar to a self-assembly process, the negatively-charged —SO₃⁻ groups of the ionomer particles would be attracted to the positively-charged Pt/V_{NH2} catalyst particles and ionomer/catalyst interfaces would spontaneously form on the catalyst particles within the resulting liquid catalyst ink (FIG. 1D). To evaluate this hypothesis, both positively-charged catalyst particles (Pt/V_{NH2}) and negatively-charged catalyst particles were evaluated to see if a thin uniform interface or a poorer (thicker and/or less uniform) interface would be constructed. The negatively-charged catalyst particles were synthesized using p-benzenesulfonic acid group (—SO₃H) functionalized carbon particles that were loaded with Pt nanoparticles (yielding catalysts referred to herein as Pt/V_{SO3H} catalysts). As a baseline, a third group of catalysts were prepared from untreated carbon particles loaded with Pt nanoparticles, resulting in neutral or “blank” catalyst particles (and yielding catalysts referred to herein as Pt/V catalysts). The carbon particles utilized for all evaluated catalysts were the conductive carbon black commercially available under the name Vulcan® XC72 from the Cabot Corporation, which was chosen due to it being a low structure carbon with very few intraparticle pores (thereby minimizing accessibility issues that could arise if Pt nanoparticles were trapped within pores in a high structure carbon, e.g., Ketjen Blacks EC300J and EC600) The Pt nanoparticle size was controlled to be 3.5±0.5 nm with a tight distribution to minimize the effect of catalyst particle size on MEA performance. Mass activity tests of the three different catalysts—i.e., the positively-charged Pt/V_{NH2}, negatively-charged Pt/V_{SO3H}, and untreated Pt/V (“blank”) catalysts—from RDE evidenced that the intrinsic mass activities of these catalysts were similar. Thus, the measured MEA performance could be concluded to be solely based on their ionomer/catalyst interfaces. These catalysts were systematically studied from the catalyst ink dispersion, interface, and MEA performance using ultra-small angle X-ray scattering (USAXS), cryo-TEM, isothermal-titration-calorimetry (ITC), HRTEM, 3-D FIB-SEM, mercury intrusion porosimetry (MIP), XPS, RDE and fuel cell testing to demonstrate the designed interface and reveal the property (ink)-structure (interface)-performance (MEA) relationship.

The investigations utilized negatively-charged ionomer particles having a —SO₃⁻ ionic domain on their surfaces. Powders of the ionomer and catalysts (Pt nanoparticles supported on treated (positive or negative) and untreated (neutral) surfaces of the carbon particles) were dispersed in a solvent to form catalyst inks within which ionomer/catalyst interfaces formed as a result of the ability of the catalyst and ionomer particles to freely move and interact in the solvent. The manner in which the ionomer/catalyst interfaces formed was theorized to depend on the electrostatic attraction, and it was critical to know to what degree such an attraction existed between the positively-charged Pt/V_{NH2} catalyst and the negatively-charged ionomer particles in the dispersion.

To determine the interaction between the ionomer and the three different catalysts, the binding entropies of the three different ionomer-catalyst combinations were measured. Isothermal titration calorimetry (ITC) was conducted on three types of carbon particles in a mixture of water and isopropanol with an ionomer to determine the association constant K_{A} for binding between the ionomer and carbon particles, surface-area-normalized enthalpy of binding between the ionomer and carbon particles, and entropy of binding between the ionomer and carbon particles. The ionomer was titrated into inks formed by the catalysts dispersed in the solvent, and the heats of adsorption were measured then calculated to generate a binding isotherm. By fitting the isotherm to an independent (Langmuir) binding model, the association constant K_{A} for ionomer binding to the Pt nanoparticles was extracted. The results showed that K_{A} was greater for ionomer binding to the positively-charged Pt/V_{NH2} catalyst than for binding to the neutral (blank) Pt/V catalyst on a mass basis, indicating a stronger interaction between the ionomer and the positively-charged Pt/V_{NH2} catalyst. Furthermore, binding of the ionomer to the negatively-charged Pt/V_{SO3H} catalyst was not detectable, indicating a weak or no attractive interaction between ionomer and Pt nanoparticles of the negatively-charged Pt/V_{SO3H} catalyst.

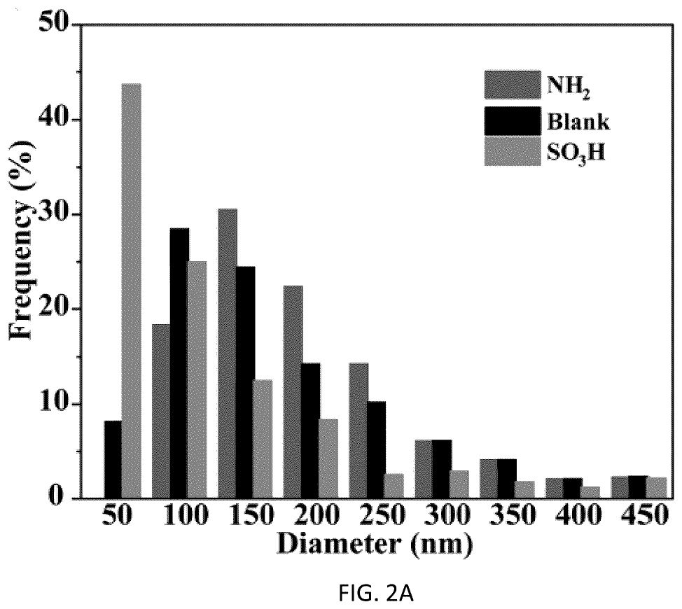

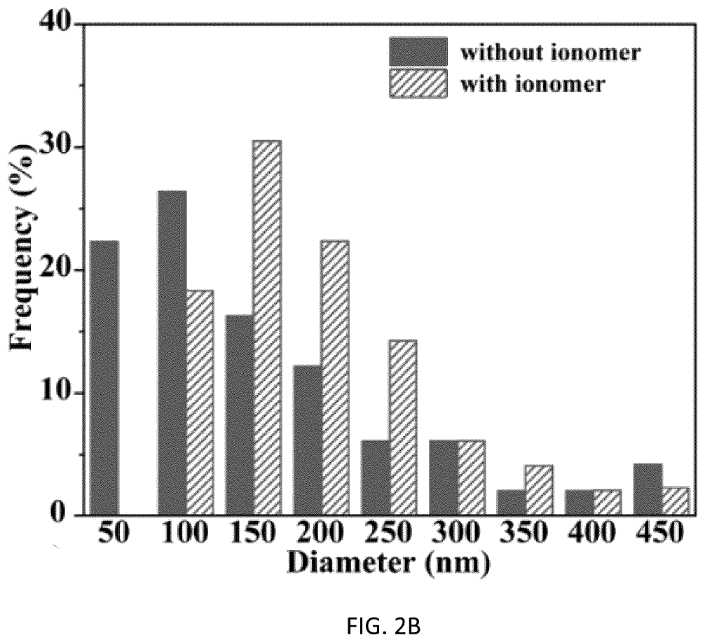

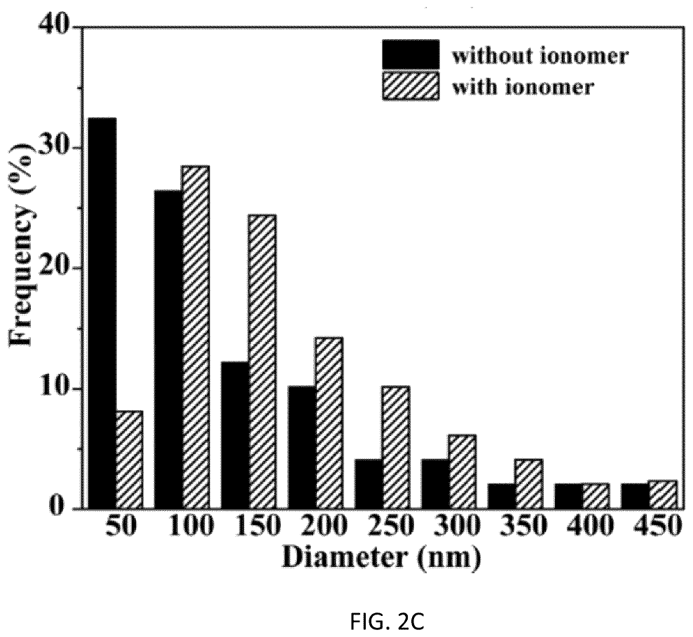

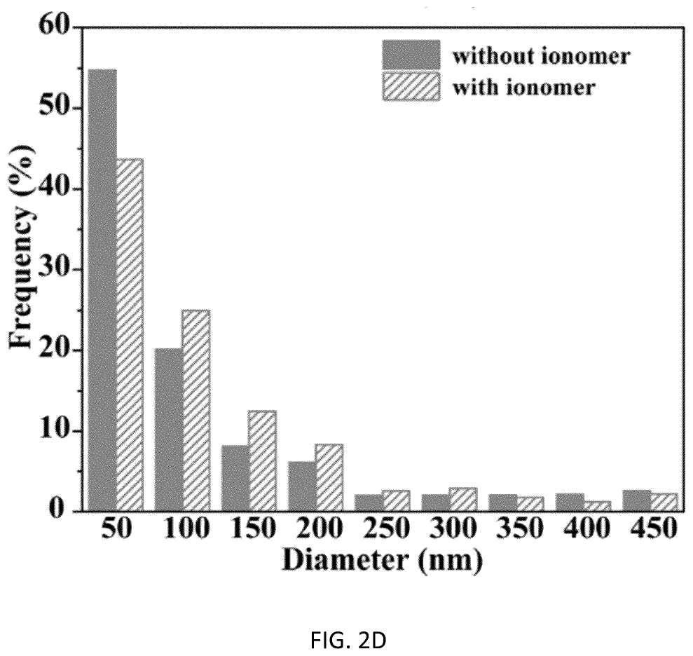

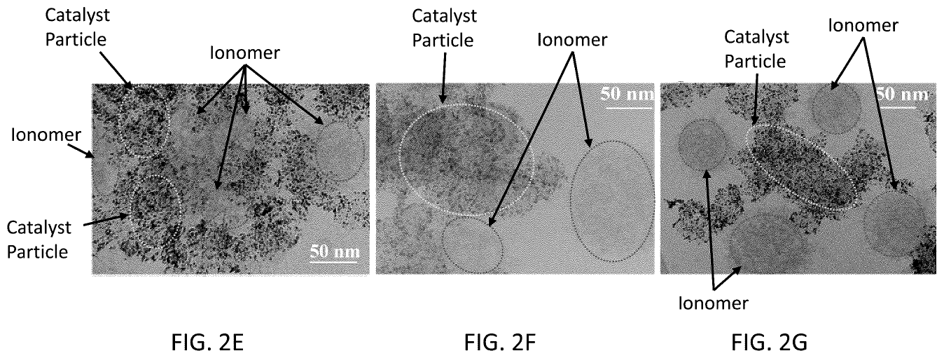

Enthalpy was also extracted from the isotherm. The surface area-normalized enthalpic contributions for binding to the positively-charged Pt/V_{NH2} catalyst and untreated Pt/V catalyst (93.6 m²/g and 254 m²/g, respectively) followed the same trend as K_{A}. Additional thermodynamic binding information was extracted after making assumptions to calculate the molar concentration of ionomer and catalyst binding sites for the positively-charged Pt/V_{NH2} and untreated Pt/V catalysts. The results showed that the entropic contribution was greater than the enthalpic contribution, consistent with previous observations for other ionomers. The entropic contribution, which was greater for the positively-charged Pt/V_{NH2} catalyst, was attributed to liberated water molecules due to hydrophobic/hydrophilic interactions upon binding. The surface area-normalized enthalpic contributions for binding to the positively-charged Pt/V_{NH2} and untreated Pt/V catalysts followed the same trend as K_{A} (FIGS. 2B-2F). Based on these results, the positively-charged —NH3⁺ functional group of the positively-charged Pt/V_{NH2} catalyst was concluded to strongly attract the negatively-charged —SO₃⁻ groups of the ionomer particles once they encountered each other within the catalyst ink. These ITC results matched very well with previous research involving Zeta potential measurements. USAXS analysis of the same three dispersions indicated that the average aggregate size of the Pt/V_{NH2} catalyst+ionomer was the largest, the average aggregate size of the Pt/V_{SO3H} catalyst+ionomer was the smallest, and the average aggregate size of the Pt/V catalyst+ionomer was in between (FIG. 2A). The Pt/V_{NH2} catalyst aggregates increased in size from 105.6±3.5 nm to 146.0±3.3 nm after mixing with the ionomer in the catalyst ink, while the average particle size of the Pt/V_{SO3H} catalyst aggregates decreased from 93.8±2.8 nm to 91.4±2.4 nm, basically evidencing no particle size change. The average particle size of the Pt/V catalyst aggregates increased from 106±1.8 nm to 116.0±2.1 nm, and therefore less than that of the Pt/V_{NH2} catalyst (FIGS. 2B-2D). The increased average catalyst aggregate size was concluded to be the result of the ionomer particles surrounding the Pt/V_{NH2} catalyst particles, strongly suggesting that a strong ionomer/catalyst interaction occurred for the positively-charged Pt/V_{NH2} catalyst while the unchanged average aggregate size was the result of non-interaction for the negatively-charged Pt/V_{SO3H} catalyst, and a weak interaction strength with the untreated Pt/V catalyst.

Cryo-TEM images of the dispersions of the prepared catalyst inks confirmed the formation of ionomer/catalyst interfaces. In the cryo-TEM image of the Pt/V_{NH2} catalyst ink shown in FIG. 2E, the catalyst particles (yellow circled regions) are surrounded by the ionomer (red circled regions), which is the result of the interaction between the positively-charged —NH₃⁺ groups on the Pt/V_{NH2} catalyst particles and the negatively-charged —SO₃⁻ ionomer particles. Furthermore, the ionomer particles can be seen spreading over and around the Pt/V_{NH2} catalyst particles, clearly demonstrating that there is an attractive electrostatic force which not only pulled the catalyst and ionomer particles together but also changed the shape/geometry of the ionomer particles as a result of overspreading and wrapping around the catalyst particles. This observation was lacking for the SO₃H functionalized Pt/V_{SO3H} catalyst seen in FIG. 2G, in which the ionomer and catalyst particles appeared to repel each other as a result of the repulsive electrostatic force pushing the catalyst and ionomer particles away from each other. The ionomer particles have a spherical shape in FIG. 2G, which is consistent with a reversed micelle structure that has been previously observed. For the neutral Pt/V catalyst shown in FIG. 2F, there is a much weaker interaction than that of the Pt/V_{NH2} catalyst of FIG. 2E. These interactions of the ionomer and the different charged groups (positively-charged, negatively-charged, and electrically neutral) catalysts exhibited a similar trend as previously reported for positively-charged, negatively-charged, and electrically neutral carbon supports, namely, positively-charged>neutral>negatively-charged, using both USAXS and cryo-TEM. It was also observed that the charges were present over the entire carbon surface such that the ionomer particles were attracted to the entire carbon surface, resulting in the Pt nanoparticle also being covered by the ionomer particles because the Pt nanoparticles were uniformly distributed over the carbon surface, hence forming an ionomer/catalyst interface. Overall, all results from ITC, USAXS and cryo-TEM clearly demonstrated the formation of an ionomer/catalyst interface in a catalyst ink containing the positively-charged Pt/V_{NH2} catalyst.

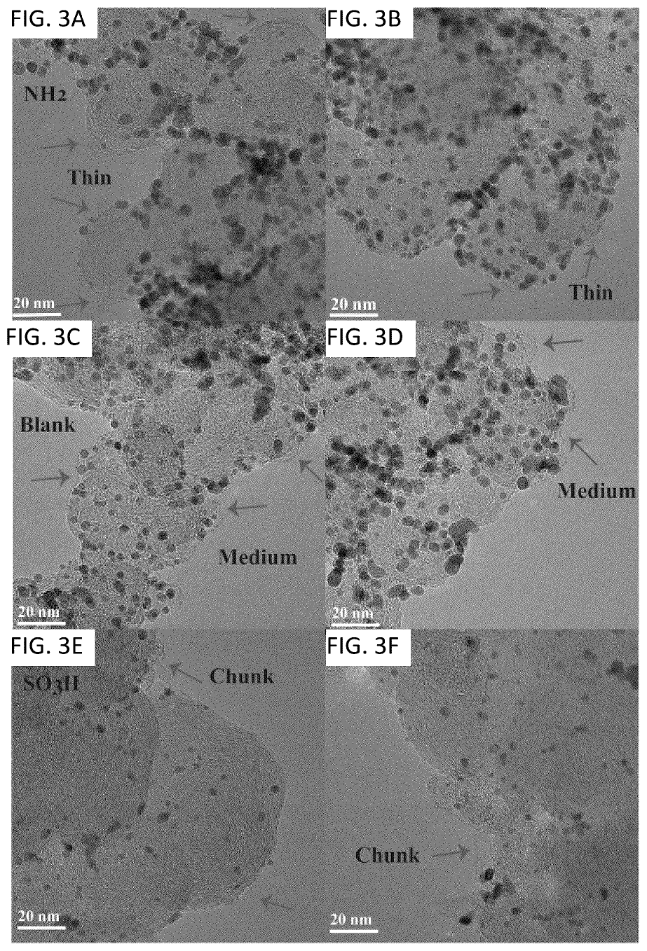

Cryo-TEM was employed to visualize the distribution of thin ionomer layers over the carbon-supported Pt in catalyst layers formed by spraying and drying the catalyst inks. TEM has been used to resolve ionomer layers on highly graphitic and non-carbon supports, but it is more challenging to distinguish and ionomer from carbon on less graphitized supports such as the Vulcan® XC72 conductive carbon black used in the investigations. This can be evidenced in cryo-TEM images of the ionomer-free XC72 (Pt/V) powder in which a thin carbon layer could be easily misidentified as ionomer. Mapping the fluorine signal using spectroscopic methods such as electron energy loss spectroscopy (EELS) or energy dispersive X-ray spectroscopy (EDS) is another approach for distinguishing an ionomer from a carbon support, but the high sensitivity of the ionomer polymer to the electron beam typically limits the application of spectroscopy methods to thicker layers or agglomerates, even when cryogenic cooling is applied to slow radiolysis. The TEM image acquisition and analysis were performed as a double blind experiment to prevent any human bias during the recording or interpretation of the low dose cryo-EM data. The regions used for imaging were randomly selected by the instrument operator. Four researchers participated in image interpretation and analysis with no prior knowledge regarding the differences between the samples to determine if there was consensus regarding differences in ionomer distribution as a result of the surface treatment. Characteristic images from the Pt/V_{NH2}, Pt/V, and Pt/V_{SO3H} powders scraped from the cathodes prepared with the catalyst layers are shown in FIGS. 3A-3F. Thin films attributed to ionomer were more prevalent over the Pt/V_{NH2} catalyst particles (FIGS. 3A and 3C, red dash line circled regions) with respect to the Pt/V catalyst particles, in which bare carbon and Pt surfaces were intermittently interrupted by larger agglomerates (FIGS. 3C-3D red dash line circled regions). The thickest agglomerate in FIG. 3F was observed (FIGS. 3E-3F), and confirmed to be ionomer by STEM-EELS, although the F fluorine edge was fainter than expected, indicating that radiolysis damage occurred even under low dose cryo-TEM imaging conditions. The qualitative differences in ionomer dispersion observed in cryo-TEM image provided additional support to the theory that ionomer dispersion can be influenced by controlling the electrostatic charge of the carbon surface, as conceptualized in (FIG. 1D).

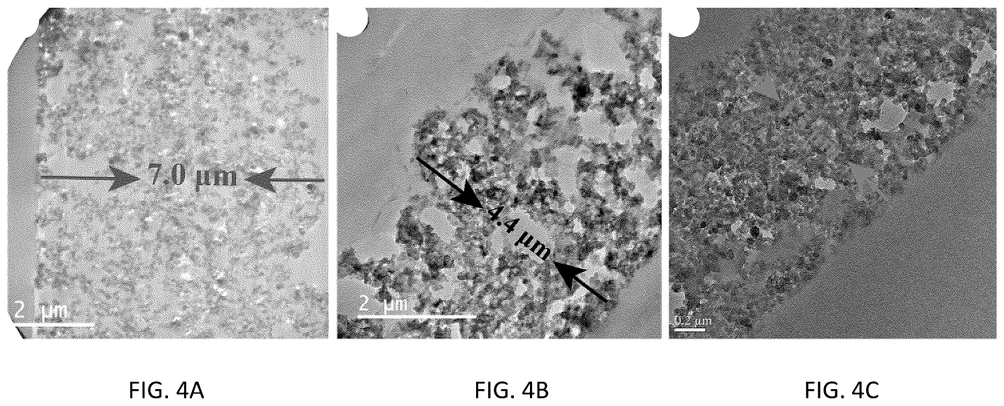

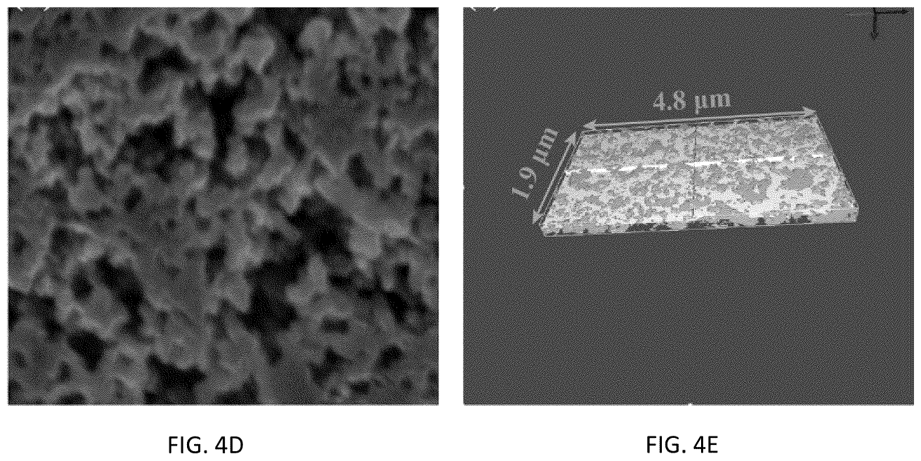

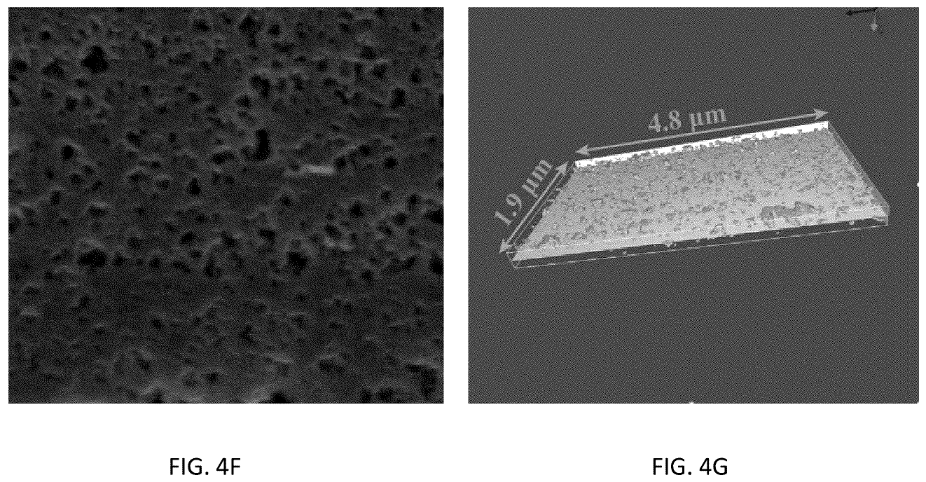

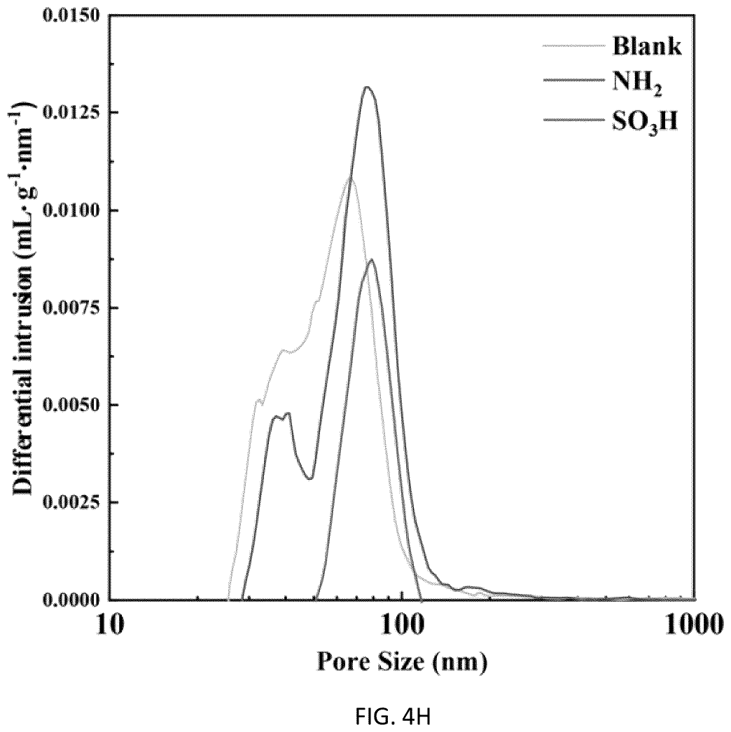

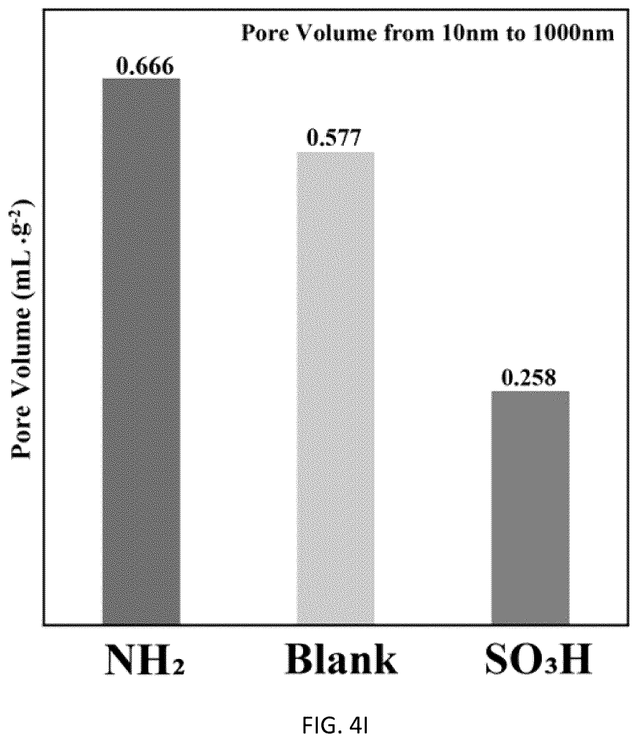

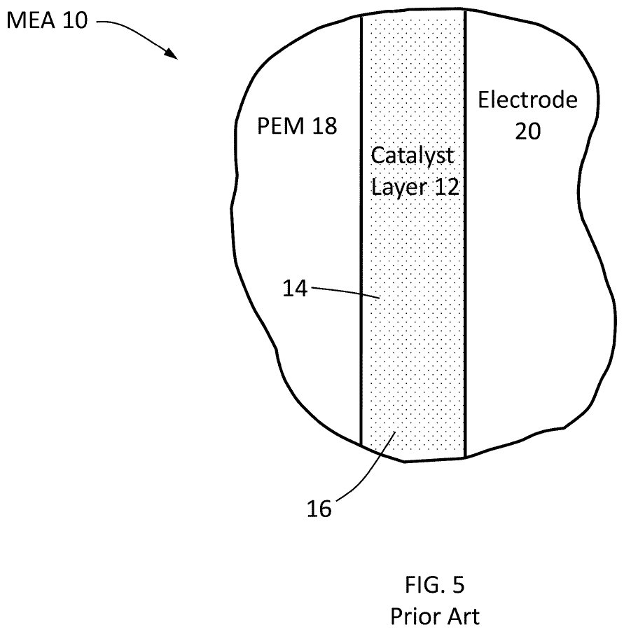

It was observed that the catalyst layers formed with the three different catalysts were significantly different. Each layer exhibited a different thickness: the catalyst layer formed with the positively-charged Pt/V_{NH2} catalyst (FIG. 4A) was the thickest at 7.0 m, the catalyst layer formed with the neutral Pt/V catalyst (FIG. 4B) had a thickness of 4.4 m and between the thicknesses of the Pt/V_{NH2} catalyst layer and the negatively-charged Pt/V_{SO3H} catalyst layer (1.5 μm in FIG. 4C). Since the catalyst loading and ionomer/carbon (I/C) ratios were all the same among the prepared catalyst layers, the measured differences in thickness were attributed to changes in the pore structures of the catalyst particles. To better understand the pore structures, the catalyst layers were subjected to an FIB/slice and view procedure, where sections of around 10 nm were sliced by FIB and then observed by SEM. Two of these sections are shown in FIGS. 4D and 4F, which shows that the pore size distribution in the Pt/V_{NH2} catalyst layer was significantly larger than in the Pt/V_{SO3H} catalyst layer. This was even more evident after visualizing the catalyst layers after a 3-D reconstruction of all the slices taken (FIGS. 4E and 4G). In addition, mercury intrusion porosimetary (MIP) measurements gave both the global view and local detailed information of the pore structures of catalyst layers formed with the three catalysts (FIGS. 4H and 4I). The results corresponded to the thicknesses of the catalyst layers: the largest pore volume in the range from 10 nm to 1000 nm was 0.666 mL g⁻¹ in the Pt/V_{NH2} catalyst layer, followed by 0.577 mL g⁻¹ in the neutral (“blank”) Pt/V catalyst layer, and then 0.258 mL g⁻¹ for the Pt/V_{SO3H} catalyst layer. The pore structure in the last range strongly affects the O₂ mass transport in gas phase within a catalyst layer. For more details, pores are highlighted in the 3-D structures shown in FIGS. 4E and 4G, evidencing that there was a huge difference in pores size distribution and total pore volume between the Pt/V_{NH2} and Pt/V_{SO3H} catalyst layers. For the pore structure exhibited by the Pt/V_{NH2} catalyst layer, one hypothesis is that the larger Pt/V_{NH2} and ionomer particles (measured by USAXS) resulting from the interaction led to a lower packing ratio, causing an increase in pore volume. Another possibility is that the shrinkage of the ionomer film surrounding the Pt/V_{NH2} particles of the Pt/V_{NH2} catalyst layer led to more void space.

The intrinsic catalytic performances of the three catalysts were determined using RDE. In order to eliminate the effect of the different interactions between catalyst and ionomer, ionomer-free catalyst inks containing the positively-charged Pt/V_{NH2} catalyst particles, negatively-charged Pt/V_{SO3H} catalyst particles, and neutral (“untreated”) Pt/V catalyst particles were used for RDE testing. Mass activities (MA) of the three catalysts from RDE are quite close: 298 mA-mg⁻¹_{Pt}, 286 mA-mg⁻¹_{Pt}, and 278 mA-mg⁻¹_{Pt} for Pt/V_{NH2}, Pt/V, and Pt/V_{SO3H} catalysts, respectively. The almost identical polarization curves of these three catalysts also suggest that they had very similar intrinsic ORR performances.

MEAs were prepared using a catalyst coated membrane (CCM) method in which catalyst inks were directly sprayed onto a proton exchange membrane (PEM) (Gore® 10 mm) placed on a hot plate at 70° C. using the active geometric area of the MEAs as 5 cm². The positively-charged Pt/V_{NH2}, negatively-charged Pt/V_{SO3H}, and neutral (“untreated”) Pt/V catalyst particles were mixed with water, n-propanol, and an ionomer (Aquivion D72-25BS) by ultrasonication. For comparison, identical anode catalyst layers were prepared with Pt loadings of 0.1 mg_{Pt} cm⁻² (±0.01) using 20 wt % Pt-XC72 with a 0.45 I/C ratio through the same CCM method described above. For the cathodes, except for the difference in catalyst, all conditions were the same, including the Pt loading and solvents, but the I/C ratio was controlled to 0.35. The Pt loading of the cathodes was controlled to 0.107 mg_{P}t cm⁻² (±0.01). The MEAs were assembled with a Sigracet® 22BB gas diffusion layer (GDL).

Each of these there MEAs was tested to measure H₂-air fuel cell I-V polarization recorded with the cathodes in a differential cell under 150 kPa_{abs} of air pressure at an air flow rate of 2000 sccm and an H₂ flow rate of 500 sccm, as well as to measure mass activity and ECSA of the cathodes, current density at 0.6 V and 0.67 V of the cathodes, and power density at 0.6 V and 0.67 V of the cathodes. The testing showed that the MEA with the Pt/V_{NH2} catalyst exhibited the highest MEA performance, ECSA, and mass activity. In contrast, the testing showed that the Pt/V_{SO3H} MEA had the lowest mass activity and ECSA, and that the Pt/V catalyst MEA again exhibited performances between the two. The measured mass activities were 190 mA cm⁻², 160 mA cm⁻², and 78 mA cm⁻² and the ECSAs were 52.38 m² g⁻¹_{Pt}, 46.42 m² g⁻¹_{Pt}, and 25.31 m² g⁻¹_{Pt} for the Pt/V_{NH2}, Pt/V, and Pt/V_{SO3H} catalysts, respectively. These results demonstrated that the ionomer coverage over the Pt nanoparticles of the catalysts differed among the three catalysts: the ionomer coverage was the highest for the Pt/V_{NH2} catalyst and lowest for the Pt/V_{SO3H} catalyst. Consequently, the higher ionomer coverage of the former led to higher Pt utilization and higher mass activity, which indicated that there was a larger ionomer/catalyst interface for the Pt/V_{NH2} catalyst compared to the Pt/V_{SO3H} catalyst. The high mass activity and ECSA of the Pt/V_{NH2} catalyst evidenced the benefit of constructing an ionomer/catalyst interface utilizing charge attraction between the ionomer and catalyst. The Pt/V_{NH2} MEA achieved an outstanding performance among the three catalysts not only in the kinetics-controlled region (i.e., mass activity and ECSA), but also in mixing-controlled and mass transfer-controlled regions (i.e., rated/peak power density). The rated power density (power density at 0.67 V) of the Pt/V_{NH2} MEA reached 910 mW cm⁻² which was not only outstanding compared to the other two catalysts, but was also comparable with published high active Pt alloy catalysts such as PtNi, PtNiN, and PtCo. The rated power density of the Pt/V and Pt/V_{SO3H} catalyst MEAs were 729 mW cm⁻² and 440 mW cm⁻², respectively. Further, the helox (21 vol % O₂ in He) test was performed on the three MEAs following H₂-air tests on the same MEAs to assess the O₂ diffusion resistance in N₂. The performance gains of the MEA from testing in helox relative to air represented the O₂ transfer resistance in gas phase, e.g., in an N₂ blanket. Performance gains of the three MEAs were observed to follow the trend seen herein that Pt/V_{NH2}<neutral (“blank”) Pt/V<Pt/V_{SO3H}. Lower performance gains suggested high porosity in the catalyst layer, and was consistent with the MIP and FIB-SEM results mentioned above.

The highest rated power density of the Pt/V_{NH2} MEA evidenced that the formed ionomer films over the Pt nanoparticles were more uniform and thinner than those of the Pt/V and Pt/V_{SO3H} catalyst MEAs. In high current density regions, the diffusion of O₂ molecules through the ionomer film of an ionomer/catalyst interface to the Pt surface of the catalyst is the rate-limiting step with the assumption that O₂ molecule diffusion in an N₂ blanket (e.g., air) through the pores of the catalyst layer is much faster. Hence, the current density of a catalyst layer of an MEA is controlled by the limiting current density of O₂ molecule diffusing through the ionomer film. The thinner the ionomer film, the shorter the O₂ molecule diffusion length in the ionomer film and the higher the limiting current density. Since all MEAs of the three evaluated catalysts used the same I/C ratio, namely, the same ionomer content, then a uniformly distributed ionomer over a catalyst and carbon support surface (same particle size, same surface area) of the Pt/V_{NH2} catalyst should have a thinner ionomer film than a non-uniformed ionomer film, such as observed for the Pt/V_{SO3H} catalyst.

To further establish that O₂ molecule diffusion via the ionomer film (i.e., O₂ transport resistance) is the limiting step and that the Pt/V_{NH2} catalyst has a more uniform and thinner ionomer film than that of the Pt/V_{SO3H} catalyst, the O₂ molecule diffusion resistance (Rₜₒₜₐₗ, (s/m)) was studied. Rₜₒₜₐₗ is defined as the total diffusion resistance from the outer surface of the diffusion media to the surface of a Pt nanoparticle, where R_{DM} is the O₂ diffusion resistance in diffusion media. The O₂ of the air transport within a catalyst layer entails two processes: O₂ molecules diffuse in the N₂ blanket (e.g., air) within the pores of the catalyst layer to reach the ionomer/catalyst interface, and then O₂ molecules diffuse through the ionomer film to reach the surfaces of the Pt nanoparticles (FIG. 1C). The effect of mass transport usually is expressed as the transport resistance. The resistance of O₂ transport in N₂ gas is referred to as the gas phase transport resistance (R_{CL,gas}, (s/m)) and mainly controlled by the pore structure of the catalyst layer, and the diffusion resistance through the ionomer film to the catalyst surface is referred to as the solid phase transport resistance (R_{CL,ion}, (s/m)).

$${R}_{total} = {R}_{DM} + {R}_{CL , gas} + {R}_{CL , ion} \qquad ( Eq . 1 )$$

To quantify how much improvement that the positively-charged Pt/V_{NH2} catalyst particles promoted ionomer coverage and consequently, reduced the thickness of ionomer film on the catalyst carbon support (CCS), limiting current density measurements were conducted at different relative humidities for all three catalysts. q is defined as an index to reflect the quality of ionomer film over CCS, and

$$q = \frac{{δ}_{ion}^{eff}}{{A}_{ion}^{eff}} .$$

where δᵢₒₙ^{eff} is the effective ionomer thickness (m) and Aᵢₒₙ^{eff} is the effective ionomer area for oxygen permeation (m²·m⁻²). A large q value indicates either a large δᵢₒₙ^{eff} (suggesting a thicker ionomer film) or a small Aᵢₒₙ^{eff} (suggesting a small efficient ionomer coverage), which results in either slow diffusion of O₂ molecules through the ionomer film on the CCS (poorer high current density performance) or lower catalyst utilization (lower MA and ECSA). Conversely, a smaller q value suggests either a small δᵢₒₙ^{eff} (suggesting a thinner ionomer film) or a large Aᵢₒₙ^{eff} (suggesting larger efficient ionomer coverage), which results in either faster diffusion of O₂ molecules through the ionomer film on the CCS (much improved high current density performance) or higher catalyst utilization (higher MA and ECSA).

The relationship between q and R_{CL,ion} was established in Eq. 2 based on the modeling work of N. Nonoyama et al., J. Electrochem. Soc., 2011, 158, B416-B423. R_{CL,ion} is related to q and Ψ_{ion,O2}, the oxygen permeability coefficient, (mol·s⁻¹·m⁻¹·Pa⁻¹) and Ψ_{ion,O2}, is defined in Eq. 3.

$${R}_{CL , ion} = \frac{q}{{Ψ}_{ion , {O}_{2}} RT} \qquad ( Eq \text{.2} )$$

$$( Eq \text{.3} )$$

$${Ψ}_{ion , {O}_{2}} = \frac{{D}_{ion , {O}_{2}}}{{H}_{ion , {O}_{2}}} = 3.27 \times 1 {0}^{- 15} exp [ 1.28 ( RH ) ] \times exp [ \frac{17 , 200}{R} ( \frac{1}{323.15} - \frac{1}{T} ) ]$$

where D_{ion,O}_{₂} is the diffusivity of O₂ in ionomer (m²·s⁻¹) and H_{ion,O}_{₂} is the Henry constant of O₂ (Pa·m³·mol⁻¹). At a given temperature, Ψ_{ion,O2}, (mol·s⁻¹·m⁻¹·Pa⁻¹), is only the function of relative humidity (RH). For a given MEA at a fixed temperature, q is a constant (i.e., the MEA structure is fixed) and thus R_{CL,ion} is determined by Ψ_{ion,O2}. Notably, Ψ_{ion,O2} is a property of both oxygen and the ionomer. Then, a relationship of q and Rₜₒₜₐₗ was established in Eq. 4:

$$q = ( {R}_{total}^{{RH}_{1}} - {R}_{total}^{{RH}_{2}} ) b \qquad ( Eq \text{.4} )$$

where b is constant at a given temperature (e.g., 80° C.). Rₜₒₜₐₗ^{RH}^{₁} and Rₜₒₜₐₗ^{RH}^{₂} are Rₜₒₜₐₗ at RH₁ and RH₂, respectively. For a given MEA, R_{CL,gas} and R_{DM} remain constant because R_{DM} and R_{CL,gas} (i.e., the pore structure of the catalyst layer) do not change with RH. The ionic conductivities of the catalyst layers were measured and found not to significantly change under different RHs (e.g., 50% and 80% RH). Overall, since the Rₜₒₜₐₗ is the sum of R_{DM}, R_{CL,ion}, and R_{CL,gas} (Eq. 1), the difference of Rₜₒₜₐₗ at two different RHs: RH₁ and RH₂, ΔRₜₒₜₐₗ=Rₜₒₜₐₗ^{RH}^{₁}−Rₜₒₜₐₗ^{RH}^{₂} should be equal to the difference of R_{CL,ion} at two different RHs: ΔR_{CL,ion}=R_{CL,ion}^{RH}^{₁}−R_{CL,ion}^{RH}^{₂}.

A sophisticated method to calculate the Rₜₒₜₐₗ in a cathode is by limiting current density analysis. Rₜₒₜₐₗ can be obtained from the intercept of the linear plotting of total O₂ mass transfer resistance in MEA hardware against back pressure. Testing was conducted to measure O₂ diffusion resistance versus operating pressure of the MEAs with cathodes in differential cells utilizing catalyst layers formed with the positively-charged (NH₂) catalyst particles, the neutral (“blank”) catalyst particles, and the negatively-charged (SO₃H) catalyst particles at a flow rate (2 vol % O₂ in N₂) of 2000 sccm and an H₂ flow rate of 500 sccm. In addition, the O₂ diffusion resistances of each of these MEAs at 20% and 80% relative humidity (RH), and the differences between them were also measured. Limiting current density measurements were conducted at different RHs (e.g., 50% and 80% RH) to obtain the Rₜₒₜₐₗ. Measurements at 100% RH were avoided to exclude the possible interference of liquid water on O₂ transfer, especially for the Pt/V_{SO3H} catalyst. The results showed that R_{total,80% RH} was the smallest in all Rₜₒₜₐₗ. Therefore, R_{total,80% RH} was chosen as the reference to ensure all ΔRₜₒₜₐₗ have a positive value. The difference of Rₜₒₜₐₗ between two RHs was assigned as ΔR_{total,80,20}. Not surprisingly, ΔR_{total,80,20} of the Pt/V_{NH2} MEA was 2.48×10⁻² s m⁻¹, the lowest among the three MEAs, while the largest difference, 15.1×10⁻² s m⁻¹, was seen for the Pt/V_{SO3H} MEA, and the neutral (“blank”) Pt/V MEA was 5.57×10⁻² s m⁻¹. These values are related to the q of each catalyst layer, consequently, reflecting their ionomer/catalyst interface. The smallest ΔR_{total,80,20} indicated that the best interface was present on the Pt/V_{NH2} catalyst particles, and the largest ΔR_{total,80,20} suggested that the worst interface was present on the Pt/V_{SO3H} catalyst particles.

To compare the thickness of the ionomer films in the ionomer/catalyst interfaces of the three MEAs, further limiting current analysis was carried out. Two MEAs, referred to below as q_{Blank} (for the neutral (“blank”) Pt/V MEA) and q_{NH}_{₂} (for the Pt/V_{NH2} MEA), are related in the following equation,

$$\frac{{q}_{Blank}}{{q}_{{NH}_{2}}} \approx \frac{{δ}_{{ion}_{Blank}}^{eff}}{{δ}_{{ion}_{{NH}_{2}}}^{eff}} \frac{{A}_{{Pt}_{{NH}_{2}}}}{{A}_{{Pt}_{Blank}}} \approx \frac{{δ}_{{ion}_{Blank}}^{eff}}{{δ}_{{ion}_{{NH}_{2}}}^{eff}} \frac{{ECSA}_{{NH}_{2}}}{{ECSA}_{Blank}} \qquad ( Eq . 5 )$$

where A_{PtNH}_{₂} and A_{Pt}_{_{Blank}} are surface areas of Pt nanoparticles of the Pt/V_{NH2} and Pt/V catalyst layers, respectively. Plugging in the ECSA values in FIG. 3B, Eq. 5 above becomes Eq. 6 below, and by plugging in the measured ΔRₜₒₜₐₗ=Rₜₒₜₐₗ^{RH}^{₁}−Rₜₒₜₐₗ^{RH}^{₂} for the neutral (“blank”) and NH₂ catalyst layers, respectively, Eq. 5 becomes Eq. 7 below.

$$\frac{{q}_{Blank}}{{q}_{{NH}_{2}}} \approx \frac{{δ}_{{ion}_{Blank}}^{eff}}{{δ}_{{ion}_{{NH}_{2}}}^{eff}} \frac{{ECSA}_{{NH}_{2}}}{{ECSA}_{Blank}} = \frac{{δ}_{{ion}_{Blank}}^{eff}}{{δ}_{{ion}_{{NH}_{2}}}^{eff}} \times 0.87 \qquad ( Eq \text{.6} )$$

$$\frac{{q}_{Blank}}{{q}_{{NH}_{2}}} = \frac{{( {R}_{total}^{{RH}_{2}} - {R}_{total}^{{RH}_{2}} )}_{Blank}}{{( {R}_{total}^{{RH}_{1}} - {R}_{total}^{{RH}_{2}} )}_{{NH}_{2}}} = \frac{0.05656}{0.02448} \qquad ( Eq \text{.7} )$$

Solving Eq. 6 and Eq. 7 simultaneously yields the ratio of the effective thicknesses of the ionomer films on the Pt nanoparticles of the Pt/V_{NH2} and Pt/V catalyst layers, as shown below,

$$\frac{{δ}_{{ion}_{Blank}}^{eff}}{{δ}_{{ion}_{{NH}_{2}}}^{eff}} \approx 2.66 \qquad ( Eq \text{.8} )$$

Similarly, the ratio of the effective thicknesses of the ionomer films on the Pt nanoparticles of the Pt/V_{SO3H} and Pt/V_{NH2} catalyst layers are similarly obtained, as shown below,

$$\frac{{δ}_{{ion}_{{SO}_{3} H}}^{eff}}{{δ}_{{ion}_{{NH}_{2}}}^{eff}} \approx 12.9 \qquad ( Eq . 9 )$$

The R_{CL,ion} is normalized by combining the resistance of O₂ diffusion through the ionomer film (R_{CL,ion-film}) and the interfacial resistance of O₂ diffusion of the ionomer and Pt NP (R_{CL,ion&Pt interface}). The average normalized thickness of the ionomer film for the neutral (“blank”) Pt/V catalyst layer was nearly to three times greater than that of the Pt/V_{NH2} catalyst layer. Moreover, the normalized ionomer film thickness for the Pt/V_{SO3H} catalyst layer was almost thirteen times greater than that of the Pt/V_{NH2} catalyst layer.

The stability of the Pt/V_{NH2}, Pt/V, and Pt/V_{SO3H} catalyst layers were evaluated using a standard accelerating stress testing (AST) protocol recommended by the US Department of Energy (DOE), e.g., trapezoidal wave method from 0.6 V to 0.95 V with a 0.5 s rise time and a 2.5 s holding time (H₂/N₂, 80° C., 100% RH, 50/75 sccm). After 30 k AST cycles, the measured mass activity losses of the Pt/V_{NH2} and Pt/V_{SO3H} catalyst layers were about 36%, which were lower than the 42% loss measured for the Pt/V catalyst layer, suggesting that by using functionalized carbon supports, the catalyst stability in the high voltage range increased. This result agreed well with previous results obtained with RDEs. However, at 0.8 A cm⁻², the voltage loss of the Pt/V_{SO3H} catalyst layers was 138 mV, which was more than double those of the Pt/V_{NH2} and Pt/V catalyst layers, 54 mV and 50 mV, respectively. Though not wishing to be bound to any particular theory, a possible reason for this observation is that an inferior ionomer network resulted from an unevenly distributed ionomer film on the Pt particles of the Pt/V_{SO3H} catalyst layer, which was more easily damaged so that the ionomer network failed drastically, resulting in the serious issue of proton transfer. On the other hand, the stability of the Pt/V_{NH2} catalyst layer was similar with that of the Pt/V catalyst layer, suggesting that by using an NH₂-functionalized carbon support, the performance was improved without compromising stability in the low voltage range.

Realizing that critical issues for PEMFC performance exist with the ionomer/catalyst interface in the catalyst layers of an MEA where the ORR occurs, an essential and fundamental challenge for optimal PEMFC performance is to build an ideal ionomer/catalyst interface which has the maximum ionomer coverage for Pt utilization but with an ionomer film that is as thin as possible for oxygen diffusion. The above-described investigations evidenced the ability to obtain an ionomer/catalyst interface by utilizing surface charge attraction between positively-charged catalyst particles and a negatively-charged ionomer; particularly, it was shown that chemically-grafted groups such as NH₂, which carries a positive charge in an aqueous solution, has a strong interaction with the negatively-charged SO₃H in the tested ionomer particles. This strong charge attraction changed the shape/geometry of the ionomer particles and caused them to more conformally surround the positively-charged catalyst particles to form a more uniform and much thinner ionomer film as compared to prior art approaches. The formation of such an improved ionomer/catalyst interface was a spontaneous process (similar to the self-assembly process) and controllable by adjusting the surface charge density. Such an interface effectively promotes the Pt utilization and O₂ diffusion through the ionomer film. Additionally, such an interface led to a highly porous structure in the catalyst layer, which strongly boosted the O₂ transfer, leading to a higher current density performance without compromising the O₂ transfer through it. The comprehensive characterization of the tested positively-charged, negatively-charged, and neutral (blank) catalysts evidenced the formation of such an ionomer/catalyst interface in a catalyst ink containing a positively-charged catalyst (rather than through an evaporation process), which was preserved in the resulting solid catalyst layer with consequent superior MEA performance. Modeling and limiting current measurement further evidenced the formation of an improved ionomer/catalyst interface within a catalyst layer with a much greater ionomer film coverage and a thinner ionomer film over the catalyst particles.

The investigations further demonstrated that the improved ionomer/catalyst interface achieved in the investigations directly resulted in enhanced PEMFC performance. The capability to attain a more ideal ionomer/catalyst interface is of significant importance to all reactions involving a solid/gas/liquid interface, such as heterogonous catalysis (e.g., water electrolysis and electrolysis in alkali industry, etc.) and other applications (e.g., solid-state batteries, etc.). This capability opens possibilities for developing highly efficient devices for energy conversion/storage (e.g., fuel cells, batteries), hydrogen production (e.g., water electrolysis) and other applications (e.g., alkaline industry). The investigations also suggested an approach for dealing with complicated challenges faced in such applications through a more thorough understanding of the challenges, solving the problem from fundamentals, obtaining a more ideal the ionomer/catalyst interface, and engineering the construction of such an interface based on the property-structure-performance relationship.

As previously noted above, though the foregoing detailed description describes certain aspects of one or more particular embodiments of the invention and investigations associated with the invention, alternatives could be adopted by one skilled in the art. For example, process parameters such as temperatures and durations could be modified, and appropriate materials could be substituted for those noted. As such, and again as was previously noted, it should be understood that the invention is not necessarily limited to any particular embodiment described herein or illustrated in the drawings.

1. A catalyst layer comprising:
a catalyst support having surfaces that are positively charged;
nanoparticles on the surfaces of the catalyst support; and
negatively-charged ionomer films on the catalyst support and the nanoparticles thereon, the ionomer films being uniform, conformal, and thin over the nanoparticles.

2. The catalyst layer of claim 1, wherein surfaces of the catalyst support are positively charged with —NH₃⁺ functional groups.

3. The catalyst layer of claim 2, wherein surfaces of the catalyst support are covalently grafted with p-benzylamine group to have the —NH₃⁺ functional groups on the surfaces thereof.

4. The catalyst layer of claim 2, wherein surfaces of the catalyst support are covalently grafted with at least one of polyaniline, polybenzimidazole, and derivatives thereof to have the —NH₃⁺ functional groups on the surfaces thereof.

5. The catalyst layer of claim 1, wherein the ionomer films have negatively-charged SO₃⁻ groups on surfaces thereof.

6. The catalyst layer of claim 1, wherein the ionomer films are formed of a sulfonated tetrafluoroethylene-based fluoropolymer copolymer.

7. The catalyst layer of claim 1, wherein the ionomer films are formed of at least one of p-benzenesulfonic acid, p-benzoic acid, and derivatives thereof.

8. The catalyst layer of claim 1, wherein the nanoparticles are one or more of Pt, Rh, Pd, Ag, Au, Ni, Os, Ir, Mn, and Co, and the alloys, intermetallics, and oxides thereof.

9. The catalyst layer of claim 1, wherein the nanoparticles are chosen from the group consisting of platinum, ruthenium, rhodium, palladium, osmium, and iridium, alloys thereof, and ordered intermetallics thereof.

10. The catalyst layer of claim 1, wherein the catalyst support comprises carbon particles.

11. A method of producing the catalyst layer of claim 1, the method comprising forming the ionomer films on the catalyst support to be uniform, conformal, and thin by controlling electrostatic charge of the surfaces of the catalyst support.

12. The method of claim 11, wherein the method comprises utilizing electrostatic charge attraction between the positively charged surfaces of the catalyst support and the negatively-charged ionomer films.

13. The method of claim 12, further comprising forming the ionomer films on the catalyst supports by combining positive charged catalyst particles and negatively-charged ionomer particles in a catalyst ink containing a solvent and then removing the solvent to form a solid ionomer film.

14. The method of claim 13, further comprising forming the ionomer films on the catalyst supports by dispersing in the solvent an ionomer powder and a catalyst powder of positively-charged carbon particles having the nanoparticles on surfaces thereof to form the catalyst ink within which ionomer/catalyst interfaces form as a result of the ability of particles of the catalyst powder and the ionomer powder to freely move and interact in the solvent.

15. A membrane electrode assembly comprising the catalyst layer of claim 1.

16. A polymer electrolyte membrane fuel cell comprising the membrane electrode assembly of claim 15.

17. The polymer electrolyte membrane fuel cell of claim 16, wherein the polymer electrolyte membrane fuel cell is installed in a vehicle.
